(19) United States
(12) Patent Application Publication
(10) Pub. No.: US 2019/0266994 A1
(43) Pub. Date: Aug. 29, 2019

(54) ACTIVE SOUND EFFECT GENERATION SYSTEM

(71) Applicant: HONDA MOTOR CO., LTD., Tokyo (JP)

(72) Inventor: Toshio INOUE, Wako-shi, Saitama (JP)

(21) Appl. No.: 16/309,356

(22) PCT Filed: May 31, 2017
(86) PCT No.: PCT/JP2017/020354

§ 371 Date: Dec. 12, 2018

(30) Foreign Application Priority Data
Jun. 15, 2016 (JP) 2016-118848

(51) Int. Cl. G10K 15/04; G10K 15/02

(52) U.S. Cl. CPC G10K 15/04; B60Q 9/00; G10K 15/02

(57) ABSTRACT

An active sound effect generation system includes: an intake pipe microphone for detecting a vibration noise signal produced in an intake pipe of an internal combustion engine; a driver seat speaker for outputting a sound including a sound effect, and an active sound effect generation device. The active sound effect generation device includes: a reference signal generator for extracting an acoustic component belonging to a predetermined frequency band based on a rotational frequency of the engine from the vibration noise signal, and generating a harmonic reference signal based on the extracted acoustic component; and an adder for generating a control signal to be used to generate the sound effect on the basis of the reference signal, and outputting the control signal to the driver seat speaker. The reference signal generator sets a center frequency for the acoustic component based on the rotational frequency of the engine.

### TECHNICAL FIELD

The present invention relates to an active sound effect generation system for producing a sound effect in a vehicle equipped with an internal combustion engine.

### BACKGROUND ART

The applicant has proposed a sound effect generation device for generating an engine sound with a feeling of linearity to an acceleration operation in a vehicle equipped with an internal combustion engine (see Patent Literature 1).

The sound effect generation device described in Patent Literature 1 includes: a waveform data table storing waveform data for one cycle of a sine wave; a reference signal generator for generating a harmonic reference signal based on a rotational frequency of the engine by referring to the waveform data; an acoustic controller for generating a control signal based on the reference signal; and an output device for converting the control signal into a sound effect, and outputting the sound effect. The acoustic controller includes a first acoustic corrector having a reverse gain characteristic which is reverse to a frequency-gain characteristic (characteristic in which the gain changes in accordance with the frequencies of the reference signal) of a sound field space extending from the output device to an occupant, and generates the control signal based on the reference signal by causing the first acoustic corrector to correct the gain for the reference signal depending on the frequencies.

When the sound effect generation device described in Patent Literature 1 applies the reverse gain characteristic to the gain for the reference signal, the frequency-gain characteristic of the sound effect is flat at a time when the sound effect based on the reference signal reaches the occupant from the output device via the sound field space. Thus, the sound effect generation device is capable of generating a sound effect with a feeling of linearity to an acceleration operation.

### CITATION LIST

### Patent Literature

Patent Literature 1: Japanese Patent Application Publication No. 2006-301598

### SUMMARY OF THE INVENTION

### Problem to be Solved by Invention

However, as the sound effect generation device described in Patent Literature 1 generates the harmonic reference signal based on the engine rotational frequency by referring to the waveform data of the sine wave set in advance, the sound effect based on the generated reference signal sounds artificial. Therefore, there is room for improvement from a viewpoint of giving the driver a satisfactory sense of maneuverability. The reason for this is as follows. For example, in a case of a four-cylinder four-stroke engine which is a type of internal combustion engine, the cylinders stagger their strokes of intake, compression, explosion, and exhaust in this order in the time sequence. This causes variation in the torque of the engine to accordingly vibrate the engine, and also changes the intake and exhaust pressures of the cylinders with each passing moment. As a result, not only does the actual engine sound include high-order frequency components, but also frequency components in a distorted waveform which is caused because the cranks do not rotate at a constant speed are randomly superimposed onto the actual engine sound. On the other hand, the sound effect generation device described in Patent Literature 1 cannot reproduce the waveform of distorted sine waves except for the high-order frequency components.

The present invention has been made in view of the above actual situation. An object of the present invention is to provide an active sound effect generation system capable of creating a sound effect which gives a satisfactory sense of maneuverability to a driver in a vehicle equipped with an internal combustion engine.

### Means for Solving Problem

For the purpose of achieving the above object, an active sound effect generation system according to a first aspect of the invention includes: a vibration noise signal detector for detecting a vibration noise signal produced in at least one of an intake-side member and an exhaust-side member for an internal combustion engine; a sound output device for outputting a sound including a sound effect, and an active sound effect generation device. The active sound effect generation device includes: a reference signal generator for extracting an acoustic component belonging to a predetermined frequency band based on a rotational frequency of the engine from the vibration noise signal, and generating a harmonic reference signal based on the extracted acoustic component; and a generator for generating a control signal to be used to generate the sound effect on the basis of the reference signal, and outputting the control signal to the sound output device. The reference signal generator sets a center frequency for the acoustic component on the basis of the rotational frequency of the engine.

The active sound effect generation device according to the first aspect of the invention employs the configuration in which the reference signal generator sets the center frequency for the acoustic component on the basis of the rotational frequency of the internal combustion engine when the reference signal generator extracts the acoustic component belonging to the predetermined frequency band on the basis of the rotational frequency of the engine from the vibration noise signal produced in the at least one of the intake-side member and the exhaust-side member for the engine.

The active sound effect generation system according to the first aspect of the invention is capable of creating a sound effect which gives the driver a satisfactory sense of maneuverability. This is because the reference signal generator sets the center frequency for the acoustic component based on the rotational frequency of the engine when the reference signal generator extracts the acoustic component belonging to the predetermined frequency band on the basis of the rotational frequency of the engine from the vibration noise signal.

An active sound effect generation system according to a second aspect of the invention is the active sound effect generation system according to the first aspect, characterized in that the reference signal generator sets the center frequency for the acoustic component in such a way as to follow a change in the rotational frequency of the engine.

The active sound effect generation system according to the second aspect of the invention is capable of generating a sound effect close to an acceleration sound of the engine to give the driver a satisfactory sense of maneuverability, and to create a sense of unity in which the driver feels as if the vehicle moves like the limbs of the driver. This is because the reference signal generator sets the center frequency for the acoustic component in such a way as to follow the change in the rotational frequency of the engine.

An active sound effect generation system according to a third aspect of the invention is the active sound effect generation system according to the first or second aspect, characterized in that the reference signal generator sets a width of the predetermined frequency band of the acoustic component on the basis of the rotational frequency of the engine.

The active sound effect generation system according to the third aspect of the invention is capable of generating a more natural sound effect in accordance with the degree of the acceleration of the engine to give the driver a satisfactory sense of maneuverability and, in addition, to create a sense of unity in which the driver feels as if the vehicle moves like the limbs of the driver. This is because the reference signal generator sets the width of the predetermined frequency band of the acoustic component on the basis of the rotational frequency of the engine.

An active sound effect generation system according to a fourth aspect of the invention is the active sound effect generation system according to any one of the first to third aspects, characterized in that the vibration noise signal detector detects a vibration noise signal produced in an intake pipe member through which the engine and an air cleaner communicate with each other as the vibration noise signal produced in the intake-side member for the engine.

The active sound effect generation system according to the fourth aspect of the invention is capable of generating an intake noise of the engine, including the acoustic component belonging to the frequency band based on the rotational frequency of the engine, as the sound effect, to thereby create a sound effect which gives the driver a satisfactory sense of maneuverability. This is because the vibration noise signal detector detects the vibration noise signal produced in the intake pipe member through which the engine and the air cleaner communicate with each other as the vibration noise signal produced in the intake-side member for the engine.

An active sound effect generation system according to a fifth aspect of the invention is the active sound effect generation system according to any one of the first to third aspects, characterized in that the vibration noise signal detector detects a vibration noise signal produced in an exhaust pipe member through which the engine and a muffler communicate with each other as the vibration noise signal produced in the exhaust-side member for the engine.

The active sound effect generation system according to the fifth aspect of the invention is capable of generating an exhaust noise of the engine, including the acoustic component belonging to the frequency band based on the rotational frequency of the engine, as the sound effect, to give the driver a satisfactory sense of maneuverability. This is because the vibration noise signal detector detects the vibration noise signal produced in the exhaust pipe member through which the engine and the muffler communicate with each other as the vibration noise signal produced in the exhaust-side member for the engine.

### Advantageous Effect of Invention

The active sound effect generation system according to the present invention is capable of creating a sound effect which gives a satisfactory sense of maneuverability to the driver in a vehicle equipped with an internal combustion engine.

### BRIEF DESCRIPTION OF DRAWINGS

FIG. 1 is a schematic configuration diagram of a vehicle with an active sound effect generation system including an active sound effect generation device (hereinafter referred to as an “ASC device” in some cases) according to an embodiment of the present invention.

FIG. 2 is a schematic configuration diagram of how the ASC device according to the embodiment of the present invention and peripheral devices are configured in order to employ intake noise from an internal combustion engine as a sound effect.

FIG. 3 is a block configuration diagram illustrating an internal configuration of the ASC device.

FIG. 4 is a block configuration diagram illustrating an internal configuration of a reference signal generator included in the ASC device.

FIG. 5 is an explanatory diagram illustrating an example of a sound pressure-frequency characteristic of the sound effect which is observed when a value of a step size parameter is changed in the reference signal generator included in the ASC device.

FIG. 6 is an explanatory diagram illustrating an example of the sound pressure-frequency characteristic of the sound effect in the reference signal generator included in the ASC device for each of higher order frequency components of an engine rotational frequency.

FIG. 7 is an explanatory diagram illustrating a comparison between an example of the sound pressure-frequency characteristic of the sound effect which is observed when the ASC device according to the present invention is on and an example of the sound pressure-frequency characteristic of the sound effect which is observed when the ASC device is off.

FIG. 8 is a schematic configuration diagram of how the ASC device according to the embodiment of the present invention and peripheral devices are configured in order to employ exhaust noise from an internal combustion engine as a sound effect.

### MODES FOR CARRYING OUT INVENTION

Hereinafter, an active sound effect generation system according to embodiments of the present invention will be described in detail with reference to the accompanying drawings.

It should be noted that in the following drawings, members having the same functions, or members having functions corresponding to each other are basically denoted by the same reference signs. In addition, sizes and shapes of members are schematically depicted by deformation or exaggeration in some case for the sake of explanatory convenience.

### Outline of Active Sound Effect Generation System 19 According to Embodiment of Present Invention

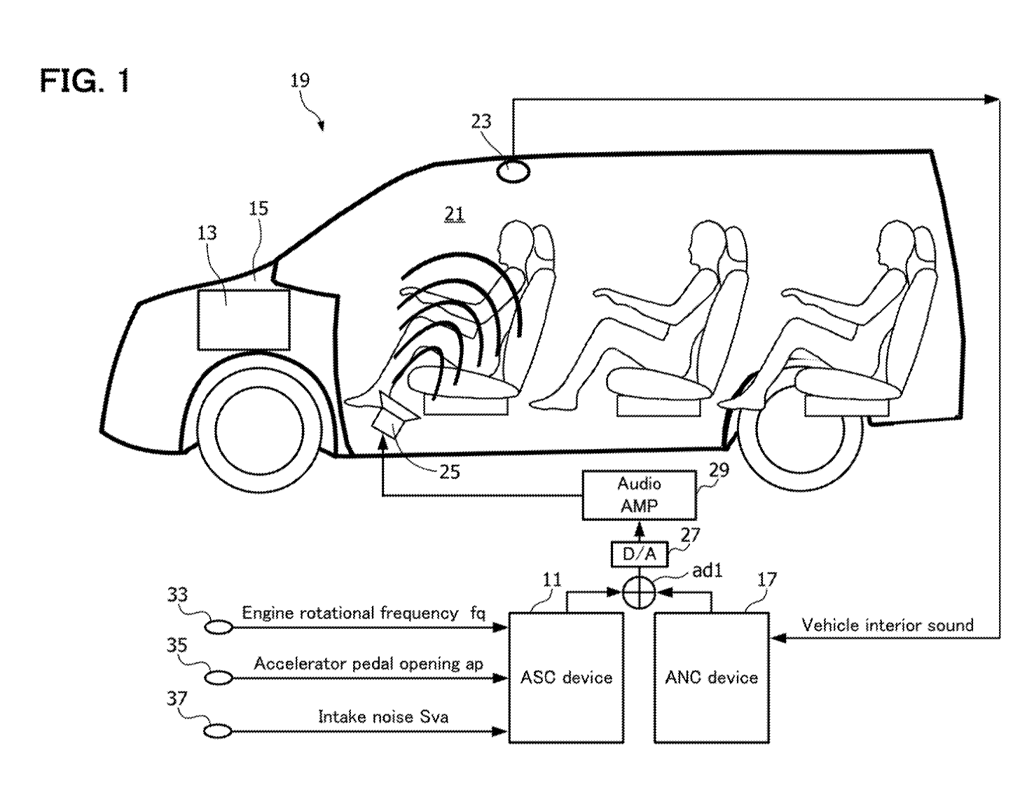

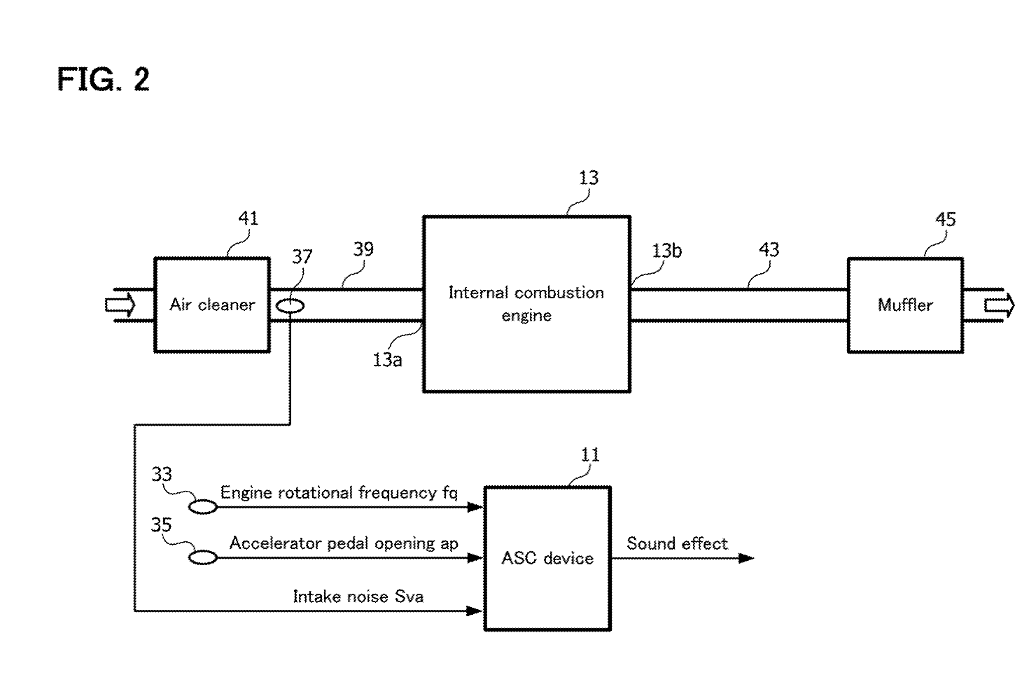

Referring to FIGS. 1 and 2, an outline of the active sound effect generation system 19 including an active sound generation device (ASC device: active sound control device) 11 according to an embodiment of the present invention will be described using an example in which the ASC device 11 is incorporated in a vehicle 15 with an internal combustion engine (hereinafter referred to as “engine”) 13 mounted thereon. FIG. 1 is a schematic configuration diagram of the vehicle 15 with the ASC device 11 mounted thereon. FIG. 2 is a schematic configuration diagram of how the ASC device 11 and peripheral devices are configured in order to employ intake noise from the engine 13 as a sound effect.

Together with an active noise control device (ANC device) 17 for actively suppressing a sound pressure of noise which enters a compartment (hereinafter referred to as “vehicle compartment” in some cases) of the vehicle 15, the ASC device 11 constitutes a vehicle active sound effect generation system 19 according to the embodiment of the present invention. The vehicle active sound effect generation system 19 has a function of: creating a driving environment which gives the driver a satisfactory sense of maneuverability; and generating a sound effect for actively suppressing the sound pressure of the noise which enters the vehicle compartment.

As illustrated in FIG. 1, the vehicle active sound effect generation system 19 including the ASC device 11 and the ANC device 17 includes: a driver seat microphone 23, provided in a driver seat space 21 in the vehicle compartment, for collecting sounds generated in the driver seat space 21; a driver seat speaker 25, provided in the driver seat space 21, for outputting sounds including the sound effect; an adder ad1 for adding up (digital) sound effect signals (sound pressure-frequency characteristics of the sound effects at a time point) respectively from the ASC device 11 and the ANC device 17; a digital-to-analog (D/A) converter 27 for converting a (digital) sound effect signal from the adder ad1 into an analog signal; and an audio amplifier 29 for amplifying an (analog) sound signal inclusive of the sound effect resulting from the conversion by the D/A converter 27, and for outputting the amplified (analog) sound signal to the driver seat speaker 25.

The driver seat speaker 25 corresponds to a “sound output device” according to the present invention.

As illustrated in FIGS. 1 and 2, various sensors including an engine rotation speed sensor 33, an accelerator pedal opening sensor 35 and an intake pipe microphone 37 are connected to the ASC device 11.

The engine rotation speed sensor 33 has a function of detecting the revolution speed of the engine 13 mounted on the vehicle 15. A time-series signal (engine rotational frequency signal) fq representing an engine rotational frequency detected by the engine rotation speed sensor 33 is sent to the ASC device 11.

The accelerator pedal opening sensor 35 has a function of detecting the accelerator pedal opening which follows the amount of the driver's depression of an accelerator pedal (not illustrated). A time-series signal (AP opening signal) ap representing an accelerator pedal opening detected by the accelerator pedal opening sensor 35 is sent to the ASC device 11.

As illustrated in FIG. 2, the intake pipe microphone 37 has a function of collecting a time-series signal (intake noise signal) Sva representing intake noise of the engine 13 which is produced in an intake pipe 39 through which an air cleaner 41 and an intake port 13a of the engine 13 communicate with, and are connected to, each other. The intake noise signal Sva collected by the intake pipe microphone 37 is sent to the ASC device 11.

The intake pipe microphone 37 is disposed on a portion of the intake pipe 35 located on the side of the air cleaner 41 and away from the engine 13. The intake pipe microphone 37 corresponds to a “vibration noise signal detector” according to the present invention. The intake pipe 39 corresponds to an “intake-side member” according to the present invention. In addition, as illustrated in FIG. 2, a muffler 45, which is for attenuating the sound pressure of the exhaust noise, communicates with, and is connected to, an exhaust port 13b of the engine 13 via an exhaust pipe 43. The exhaust pipe 43 corresponds to an “exhaust-side member” according to the present invention.

On the basis of the intake noise signal Sva, the engine rotational frequency signal fq, and the AP opening signal ap, the ASC device 11 functions to generate a natural sound effect which gives the driver a satisfactory sense of maneuverability.

### Internal Configuration of ASC Device 11

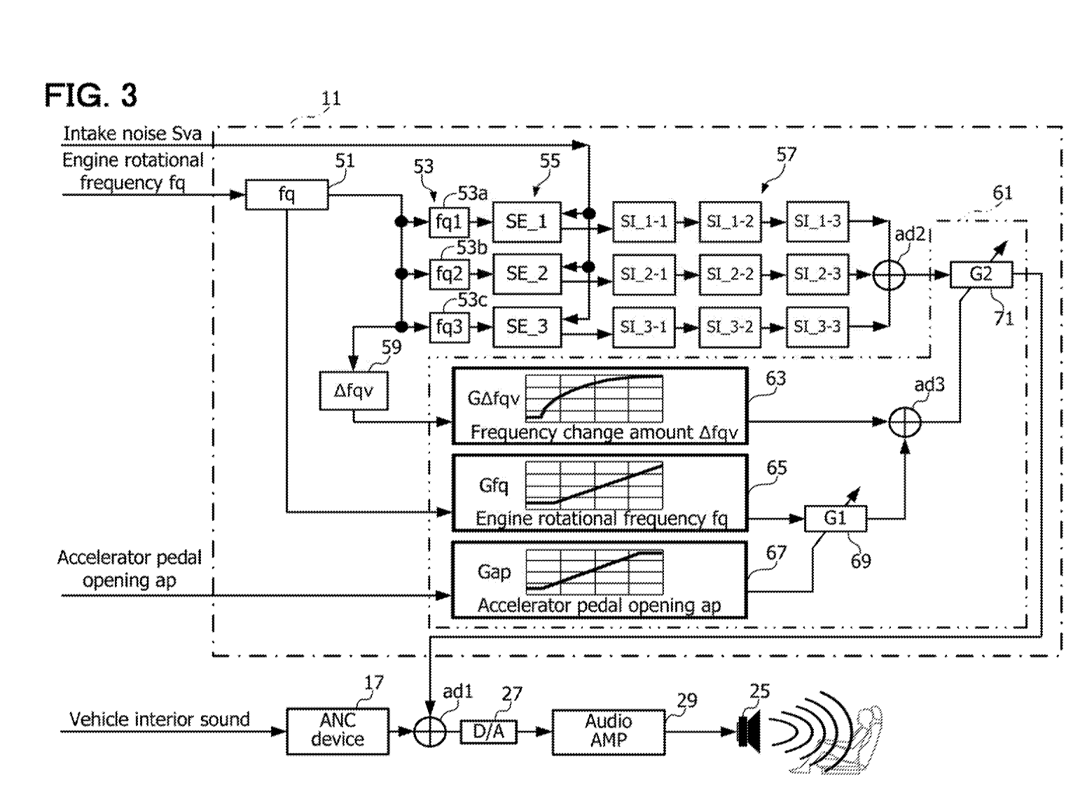

Next, referring to FIG. 3, a description will be given of an internal configuration of the ASC device 11. FIG. 3 is a block configuration diagram illustrating the internal configuration of the ASC device 11.

As illustrated in FIG. 3, the ASC device 11 includes a frequency detector 51, a multiplier section 53, a reference signal generator 55, a control signal generator 57, an adder ad2, a frequency change amount calculator 59, and a sound pressure corrector 61. The ASC device 11 performs various signal processes in the digital signal format.

Specifically, the ASC device 11 is, for example, a microcomputer including a central processing unit (CPU), a read-only memory (ROM), and a random access memory (RAM).

The frequency detector 51 has a function of: detecting the frequency of engine pulses (engine rotational frequency fq) each of which is obtained from a Hall element or the like each time the output shaft (not illustrated) of the engine 13 rotates; and outputting the engine rotational frequency fq in a digital signal format.

The multiplier section 53 includes, for example, a secondary multiplier 53a for outputting a frequency twice as high as the fundamental-order engine rotational frequency fq detected by the frequency detector 51 (second-order harmonic frequency fq1), a tertiary multiplier 53b for outputting a frequency three times as high as the fundamental-order engine rotational frequency fq (third-order harmonic frequency fq2), and a quaternary multiplier 53c for outputting a frequency four times as high as the fundamental-order engine rotational frequency fq (fourth-order harmonic frequency fq3). Numbers to be multiplied by the multiplier section 53 to the fundamental-order engine rotational frequency fq are not limited to integers such as 2, 3, 4, 5, 6 and the like, and may be real numbers such as 2.5, 3.3 and the like. In addition, numbers to be multiplied by the multiplier section 53 may be intermittent numbers such as 3, 5, 7 and the like.

The reference signal generator 55 has a function of: extracting an acoustic component belonging to a predetermined frequency band which is based on the engine rotational frequency fq from the intake noise signal (vibration noise signal) Sva collected by the intake pipe microphone 37; and generating a harmonic reference signal which is based on the extracted acoustic component. In addition, the reference signal generator 55 operates to set a center frequency for the acoustic component on the basis of the engine rotational frequency fq while extracting the acoustic component belonging to the predetermined frequency band based on the engine rotational frequency fq from the intake noise signal Sva.

In this respect, the setting of the center frequency for the acoustic component on the basis of the engine rotational frequency fq while extracting the acoustic component belonging to the predetermined frequency band based on the engine rotational frequency fq from the intake noise signal Sva means extracting the acoustic component belonging to the predetermined frequency band by matching the center frequency for the acoustic component to a frequency with the highest sound pressure level among the engine rotational frequency fq.

Specifically, the reference signal generator 55 includes: a first acoustic component extractor SE_1 for extracting an acoustic component belonging to a predetermined frequency band which is based on the second-order harmonic frequency fq1 outputted from the secondary multiplier 53a; a second acoustic component extractor SE_2 for extracting an acoustic component belonging to a predetermined frequency band which is based on the third-order harmonic frequency fq2 outputted from the tertiary multiplier 53b; and a third acoustic component extractor SE_3 for extracting an acoustic component belonging to a predetermined frequency band which is based on the fourth-order harmonic frequency fq3 outputted from the quaternary multiplier 53c. Herein, the predetermined frequency band which is based on the second-order harmonic frequency fq1, the predetermined frequency band which is based on the third-order harmonic frequency fq2, and the predetermined frequency band which is based on the fourth-order harmonic frequency fq3 each mean the predetermined frequency band which is based on the engine rotational frequency fq.

The first, second and third acoustic component extractors SE_1, SE_2, SE_3 have their respective configurations with a common function. Detailed descriptions will be provided later for the internal configurations of these acoustic component extractors.

The control signal generator 57 includes: flattening processors SI_1-1, SI_2-1, SI_3-1 for applying processes of generating a sound effect with the feeling of linearity to an acceleration operation, respectively, to the sound effect reference signals generated by the reference signal generator 55; frequency emphasis processors SI_1-2, SI_2-2, SI_3-2 for applying processes of emphasizing acoustic components belonging to corresponding predetermined frequency bands, respectively, to the reference signals; and order-based correction processors SI_1-3, SI_2-3, SI_3-3 for applying order-based reference signal correction processes, respectively, to the reference signals.

The configuration of the control signal generator 57 is the same as the technical matter described in Paragraphs 0062 and the like in Patent Literature 1 (Japanese Patent Application Publication No. 2006-301598), and detailed descriptions thereof will be omitted.

The adder ad2 outputs a control signal obtained by adding up the three signals (sound pressure-frequency characteristics of the sound effect at a time point) resulting from the processes by the order-based correction processors SI_1-3, SI_2-3, SI_3-3. The adder ad2 corresponds to a “generator” according to the present invention.

The frequency change amount calculator 59 obtains a frequency fqt1 at time t1 and a frequency fqt2 at time t2 immediately after time t1 from the engine rotational frequency fq, which is a time-series data, and calculates a difference Δfq between fq1 and fq2, where Δfq=fqt2−fqt1. The frequency change amount calculator 59 multiplies this difference Δfq by the frequency fqt2 at time t2 to calculate and output a frequency change amount Δfqv (Δfqv=Δfq×fqt2) [Hz/second] of the engine rotational frequency fq per unit time, that is to say, an acceleration of the engine rotation.

The configuration of the frequency change amount calculator 59 is the same as the technical matter described in Paragraphs 0082 to 0086 and the like in Patent Literature 1 (Japanese Patent Application Publication No. 2006-301598), and detailed descriptions thereof will be omitted.

As illustrated in FIG. 3, the sound pressure corrector 61 includes a first gain setter 63, a second gain setter 65, a third gain setter 67, a first filter 69, an adder ad3, and a second filter 71.

The first gain setter 63 includes a map prepared in advance which defines a relationship of a gain with the frequency change amount Δfqv (hereinafter referred to as “frequency change amount gain GΔfqv”), and has a function of setting a frequency change amount gain GΔfqv which is based on the frequency change amount Δfqv calculated by and outputted from the frequency change amount calculator 59 by referring to the map.

The second gain setter 65 includes a map prepared in advance which defines a relationship of a gain with the engine rotational frequency fq (hereinafter referred to as “frequency gain Gfq”), and has a function of setting a frequency gain Gfq which is based on the engine rotational frequency fq detected by the frequency detector 51.

The third gain setter 67 includes a map prepared in advance which defines a relationship of a gain with the accelerator pedal opening ap (hereinafter referred to as “accelerator pedal opening gain Gap”), and has a function of setting an accelerator pedal opening gain Gap which is based on the accelerator pedal opening ap detected by the accelerator pedal opening sensor 35.

The first filter 69 has a function of generating a corrected control signal (amplitude adjustment control signal) by multiplying the frequency gain Gfq set by the second gain setter 65 by the accelerator pedal opening gain Gap set by the third gain setter 67. The corrected control signal (amplitude adjustment control signal) generated by the first filter 69 is outputted to the adder ad3.

The adder ad3 has a function of adding up the frequency change amount gain GΔfqv set by the first gain setter 63 and the corrected control signal (amplitude adjustment control signal) generated by the first filter 69. The result of the addition by the adder ad3 (gain for correcting the sound pressure-frequency characteristic of the sound effect at a time point) is outputted to the second filter 71.

The second filter 71 has a function of generating a corrected control signal by multiplying the control signal obtained by the addition by the adder ad2 of the control signal generator 57 by the result of the addition by the adder ad3. The corrected control signal generated by the second filter 71 is outputted to the adder ad1.

### Internal Configuration of Reference Signal Generator 55 Included in ASC Device 11

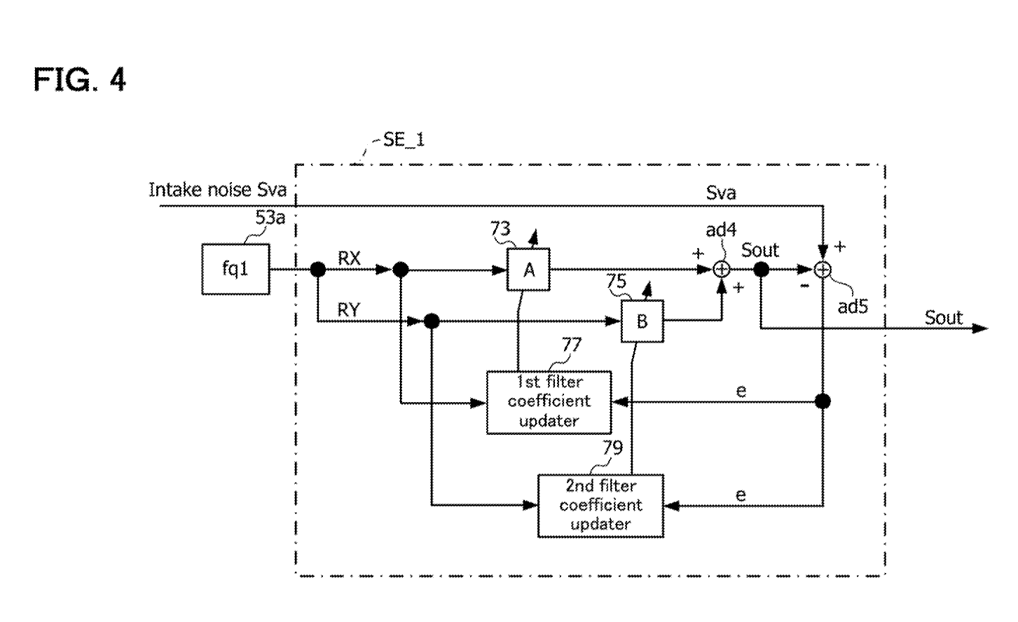

Next, referring to FIG. 4, a description will be given of the internal configuration of the reference signal generator 55 included in the ASC device 11. FIG. 4 is a block configuration diagram illustrating the internal configuration of the reference signal generator 55 included in the ASC device 11. As discussed above, the reference signal generator 55 included in the ASC device 11 includes the first, second and third acoustic component extractors SE_1, SE_2, SE_3 each having a common function. With this taken into account, the reference signal generator 55 will be described by describing the internal configuration of the first acoustic component extractor SE_1.

As illustrated in FIG. 4, the first acoustic component extractor SE_1 includes a first adaptive filter 73, a second adaptive filter 75, a first filter coefficient updater 77, a second filter coefficient updater 79, an adder ad4, and an adder ad5.

As illustrated in FIG. 4, the first adaptive filter 73, which is a digital filter, has a function of: receiving a cosine wave signal RX (RX=cos ωt, where ω=fq1) from the second-order harmonic engine rotational frequency signal fq1 outputted from the secondary multiplier 53a; and outputting a first reference signal (A×RX) obtained by multiplying the cosine wave signal RX by a first filter coefficient A.

As illustrated in FIG. 4, the second adaptive filter 75, which is a digital filter, has a function of: receiving a sine wave signal RY (RY=sin ωt, where ω=fq1) from the second-order harmonic engine rotational frequency signal fq1 outputted from the secondary multiplier 53a; and outputting a second reference signal (B×RY) obtained by multiplying the sine wave signal RY by a second filter coefficient B.

As illustrated in FIG. 4, the first filter coefficient updater 77 has a function of updating the filter coefficient A of the first adaptive filter 73 on the basis of the cosine wave signal RX and an error signal e (discussed later in detail).

Specifically, the first filter coefficient updater 77 updates the filter coefficient A of the first adaptive filter 73 by substituting the cosine wave signal RX and an error signal e in the following arithmetic equation (Equation 1) representing an adaptive least mean square (LMS) algorithm for performing an adaptive process to minimize the error signal:

Aₙ₊₁=Aₙ−μ×e×RX (Equation 1)

where RX=cos(ωt), ω=fq1, and μ is a parameter, called step size parameter, for determining the size of an update of the adaptive filters (including the first adaptive filter 73 and the second adaptive filter 75), and by calculating Equation 1.

As illustrated in FIG. 4, the second filter coefficient updater 79 has a function of updating the filter coefficient B of the second adaptive filter 75 on the basis of the sine wave signal RY (RY=sin ωt) and the error signal e.

Specifically, the second filter coefficient updater 79 updates the filter coefficient B of the second adaptive filter 75 by substituting the sine wave signal RY and the error signal e in the following arithmetic equation (Equation 2) representing an adaptive LMS algorithm:

Bₙ₊₁=Bₙ−μ×e×RY (Equation 2)

where RY=sin(ωt) and ω=fq1, and by calculating Equation 2.

The adder ad4 has a function of outputting a third reference signal Sout (Sout=(A×RX)+(B×RY)) obtained by adding up the first reference signal (A×RX) outputted from the first adaptive filter 73 and the second reference signal (B×RY) outputted from the second adaptive filter 75.

The adder ad5 has a function of outputting the error signal e (e=Sva−Sout) obtained by subtracting the third reference signal Sout, outputted from the adder ad4, from the intake noise signal (vibration noise signal) Sva collected by the intake pipe microphone 37.

### How ASC Device 11 Works

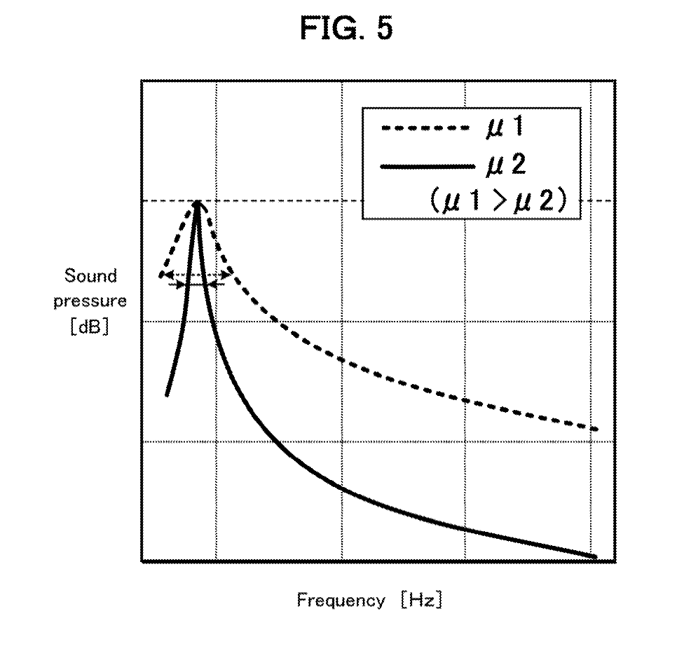

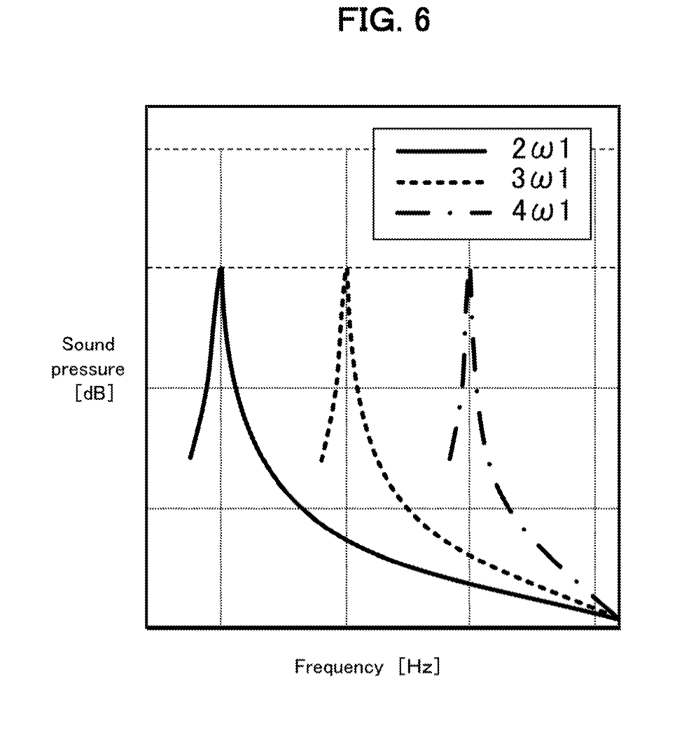

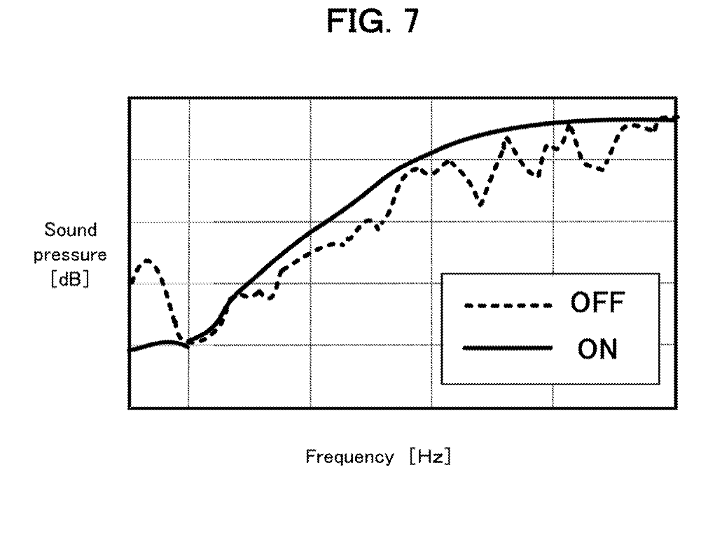

Next, referring to FIGS. 5 to 7, a description will be given of how the ASC device 11 works. FIG. 5 is an explanatory diagram illustrating an example of the sound pressure-frequency characteristic of the sound effect which is observed when the value of the step size parameter μ is changed in the reference signal generator 55 included in the ASC device 11. FIG. 6 is an explanatory diagram illustrating an example of the sound pressure-frequency characteristic of the sound effect in the reference signal generator included in the ASC device for each of the multiple higher order components of the engine rotational frequency. FIG. 7 is an explanatory diagram illustrating a comparison between an example of the sound pressure-frequency characteristic of the sound effect which is observed when the ASC device is on and an example of the sound pressure-frequency characteristic of the sound effect which is observed when the ASC device is off.

In the ASC device 11, the frequency detector 51 detects the engine rotational frequency fq, and outputs the engine rotational frequency fq in the digital signal format.

The secondary, tertiary and quaternary multipliers 53a, 53b, 53c included in the multiplier section 53 respectively output the harmonic frequencies, each of which is a corresponding predetermined number times as high as the fundamental-order engine rotational frequency fq, such as the second-, third-, and fourth-order harmonic frequencies fq1, fq2, fq3 of the fundamental-order engine rotational frequency fq detected by the frequency detector 51.

The reference signal generator 55 extracts an acoustic component belonging to a predetermined frequency band which is based on the engine rotational frequency fq from the intake noise signal (vibration noise signal) Sva collected by the intake pipe microphone 37. Specifically, the reference signal generator 55 extracts the acoustic component belonging to the predetermined frequency band by matching the center frequency for the acoustic component to a frequency with the highest sound pressure level in the engine rotational frequency fq. Subsequently, the reference signal generator 55 generates a harmonic reference signal which is based on the extracted acoustic sound.

In this respect, a description will be given of how the first, second and third acoustic component extractors SE_1, SE_2, SE_3 included In the reference signal generator 55 work. Incidentally, the first, second and third acoustic component extractors SE_1, SE_2, SE_3 have the substantially same configuration, and an explanation will be provided for how the first acoustic component extractor SE_1 works. This explanation is applicable to the second and third acoustic component extractors SE_2, SE_3.

In the first acoustic component extractor SE_1, the first adaptive filter 73 receives the cosine wave signal RX from the second-order harmonic engine rotational frequency signal fq1 outputted from the secondary multiplier 53a, and outputs the first reference signal (A×RX) obtained by multiplying the cosine wave signal RX by the first filter coefficient A.

The second adaptive filter 75 receives the sine wave signal RY from the second-order harmonic engine rotational frequency signal fq1 outputted from the secondary multiplier 53a, and outputs the second reference signal (B×RY) obtained by multiplying the sine wave signal RY by the second filter coefficient B.

The first filter coefficient updater 77 updates the filter coefficient A of the first adaptive filter 73 by substituting the cosine wave signal RX and the error signal e in the arithmetic equation (see Equation 1) representing an adaptive LMS algorithm for performing an adaptive process to minimize the error signal e, and by calculating the arithmetic equation.

The second filter coefficient updater 79 updates the filter coefficient B of the second adaptive filter 75 by substituting the sine wave signal RY and the error signal e in the arithmetic equation (see Equation 2) representing an adaptive LMS algorithm for performing an adaptive process to minimize the error signal e, and by calculating the arithmetic equation.

Appropriate adjustment of the value of the step size parameter μ included in Equations 1 and 2 makes it possible to appropriately extract the noise vibration signal produced due to a torque change and surges associated with the combustion operation of the engine 13.

For example, as illustrated in FIG. 5, when the step size parameter value μ is set at a relatively large value μ1, acoustic components belonging to a relatively wide frequency bandwidth are extracted around a frequency at which the sound pressure level determined on the basis of the sound pressure-frequency characteristic of the engine rotational frequency fq has a peak.

On the other hand, when the step size parameter value μ is set at a relatively small value μ2 (μ1>μ2), acoustic components belonging to a relatively narrow frequency bandwidth are extracted around a frequency at which the sound pressure level determined on the basis of the sound pressure-frequency characteristic of the engine rotational frequency fq has a peak.

In this embodiment, the first, second and third acoustic component extractors SE_1, SE_2, SE_3 included in the reference signal generator 55 respectively output harmonic frequencies each of which is a predetermined multiple of the fundamental-order engine rotational frequency fq, such as the second-, third-, and fourth-order harmonic frequencies fq1 (=2ω1), fq2 (=3ω1), fq3 (=4ω1) of the fundamental-order engine rotational frequency fq. Thus, as illustrated in FIG. 6, the reference signal generator 55 extracts the three acoustic components with respective sound pressure-frequency characteristics which are different from one another in terms of the peak value of the sound pressure.

The adder ad4 outputs the third reference signal Sout (Sout=(A×RX)+(B×RY)) obtained by adding up the first reference signal (A×RX) outputted from the first adaptive filter 73 and the second reference signal (B×RY) outputted from the second adaptive filter 75. The third reference signal Sout is sent to the flattening processor SI_1-1 in the control signal generator 57. The flattening processor SI_1-1 applies a predetermined process to the third reference signal Sout. The function up to this is common among the first, second and third acoustic component extractors SE_1, SE_2, SE_3.

The adder ado outputs the error signal e (e=Sva−Sout) obtained by subtracting the third reference signal Sout, outputted from the adder ad4, from the intake noise signal (vibration noise signal) Sva collected by the intake pipe microphone 37.

It should be noted that, as illustrated in FIG. 3, in the case where the reference signal generator 55 includes the first, second and third acoustic component extractors SE_1, SE_2, SE_3, the adder ad5 subtracts a composite reference signal Sout4 (Sout4=Sout1+Sout2+Sout3), obtained by adding up a 3-1st reference signal Sout1 outputted from the adder ad4 of the first acoustic component extractor SE_2, a 3-2nd reference signal Sout2 outputted from the adder ad4 of the second acoustic component extractor SE_2 and a 3-3rd reference signal Sout3 outputted from the adder ad4 of the second acoustic component extractor SE_2, from the intake noise signal (vibration noise signal, including an acoustic component for determining a tone of the acceleration sound) Sva collected by the intake pipe microphone 37. The adder ad5 outputs the error signal e (e=Sva−Sout4) obtained by this subtraction.

The flattening processors SI_1-1, SI_2-1, SI_3-1 included in the control signal generator 57 apply flattening processes for generating a sound effect with a feeling of linearity to an acceleration operation, respectively, to the sound effect reference signals (Sout1, Sout2, Sout3) generated by the reference signal generator 55.

The frequency emphasis processors SI_1-2, SI_2-2, SI_3-2 apply frequency emphasizing processes of emphasizing the acoustic components belonging to the corresponding predetermined frequency bands, respectively, to the sound effect reference signals (Sout1, Sout2, Sout3) which have been subjected to the flattening processes.

The order-based correction processors SI_1-3, SI_2-3, SI_3-3 apply order-based reference signal correction processes, respectively, to the sound effect reference signals (Sout1, Sout2, Sout3) which have been subjected to the frequency emphasizing processes.

The adder ad2 outputs a control signal obtained by adding up the three signals (respectively representing the sound pressure-frequency characteristics of the sound effect at a time point) resulting from the order-based correction processes. 3

The sound pressure corrector 61 applies a sound pressure correction process to the sound effect control signal obtained by the addition by the adder ad2. For example, in a case where the frequency change amount Δfqv is large, and in a case where the driver depresses the accelerator pedal to a large extent, the sound pressure correction process by the sound pressure corrector 61 can produce a sporty feeling by raising the sound pressure level of the sound effect.

Furthermore, even in a case where the acceleration amount and the engine rotational frequency fq change, the sound pressure correction process by the sound pressure corrector 61 can create a naturally-audible sound effect by appropriately performing weighting which is based on the sound pressure-frequency characteristics of the vehicle compartment sound field and the driver seat speaker 25 as well as the engine rotational frequency fq.

The adder ad1 adds up the (digital) sound effect control signal resulting from the sound pressure correction process by the sound pressure corrector 61 (sound pressure-frequency characteristic of the sound effect at a time point) and the (digital) sound effect signal from the ANC device 17. The (digital) sound effect signal obtained by the addition is sent to the D/A converter 27.

The D/A converter 27 converts the (digital) sound effect signal, obtained by the adder ad1's adding up the sound effect (digital) signals from the ASC device 11 and the ANC device 17, into an (analog) sound effect signal. The (analog) sound effect signal resulting from the conversion is sent to the audio amplifier 29.

The audio amplifier 29 amplifies the (analog) sound signal including the sound effect resulting from the conversion by the D/A converter 27, and outputs the resultant (analog) sound signal to the driver seat speaker 25. Thereby, the driver seat speaker 25 outputs the sound corresponding to the sound effect (intake noise).

It is learned that the sound corresponding no the sound effect (intake noise) outputted from the driver seat speaker 25, and heard near the ears of the driver has a smoother sound pressure-frequency characteristic when the ASC device 11 is on than when the ASC device 11 is off, as illustrated in FIG. 7.

### Working and Effects of ASC Device 11 According to Embodiment of Present Invention

Next, a description will be given of working and effects of the active sound effect generation system 19 according to the embodiment of the present invention. The active sound effect generation system 19 according to a first aspect includes: an intake pipe microphone (vibration noise signal detector) 37 for detecting a vibration noise signal produced in at least one of an intake pipe (intake-side member) 39 and an exhaust pipe (exhaust-side member) 43 of an internal combustion engine 13; a driver seat speaker (sound output device) 25 for outputting a sound including a sound effect, and an active sound effect generation device 11. The active sound effect generation device 11 includes: a reference signal generator 55 for extracting an acoustic component belonging to a predetermined frequency band based on a rotational frequency fq of the engine 13 from the vibration noise signal, and generating a harmonic reference signal based on the extracted acoustic component; and an adder (generator) ad2 for generating a control signal to be used to generate the sound effect on the basis of the reference signal, and outputting the control signal to the driver seat speaker 25. The reference signal generator 55 sets a center frequency for the acoustic component on the basis of the rotational frequency fq of the engine 13.

The active sound effect generation device 11 according to the first aspect employs a configuration in which the reference signal generator 55 sets the center frequency for the acoustic component on the basis of the rotational frequency fq of the engine 13 when the reference signal generator 55 extracts the acoustic component belonging to the predetermined frequency band based on the rotational frequency fq of the engine 13 from the vibration noise signal.

The active sound effect generation system 19 according to the first aspect is capable of creating a natural sound effect (acceleration sound) which gives the driver a satisfactory sense of maneuverability. This is because the reference signal generator 55 sets the center frequency for the acoustic component on the basis of the rotational frequency fq of the engine 13 when the reference signal generator 55 extracts the acoustic component belonging to the predetermined frequency band based on the rotational frequency fq of the engine 13 from the vibration noise signal.

The active sound effect generation system 19 according to a second aspect is the active sound effect generation system 19 according to the first aspect, characterized in that the reference signal generator 55 sets the center frequency for the acoustic component in such a way as to follow changes in the rotational frequency fq of the engine 13.

The active sound effect generation system 19 according to the second aspect is capable of generating a sound effect close to the acceleration sound of the engine 13 to give the driver a satisfactory sense of maneuverability, and, in addition, to create a sense of unity in which the driver feels as if the vehicle 15 moves like the limbs of the driver. This is because the reference signal generator 55 sets the center frequency for the acoustic component in such a way as to follow the change in the rotational frequency fq of the engine 13.

The active sound effect generation system 19 according to a third aspect is the active sound effect generation system 19 according to the first or second aspect, characterized in that the reference signal generator 55 sets a width of the predetermined frequency band of the acoustic component on the basis of the rotational frequency fq of the engine 13.

The active sound effect generation system 19 according to the third aspect is capable of generating a more natural sound effect in accordance with the degree of the acceleration of the engine 13 to give the driver a satisfactory sense of maneuverability and, in addition, to create a sense of unity in which the driver feels as if the vehicle 15 moves like the limbs of the driver. This is because the reference signal generator 55 sets the width of the predetermined frequency band of the acoustic component on the basis of the rotational frequency fq of the engine 13.

The active sound effect generation system 19 according to a fourth aspect is the active sound effect generation system 19 according to any one of the first to third aspects, characterized in that the intake pipe microphone (vibration noise signal detector) 37 detects a vibration noise signal produced in the intake pipe 39 through which the engine 13 and an air cleaner 41 communicate with each other as the vibration noise signal produced in the intake-side member for the engine 13.

The active sound effect generation system 19 according to the fourth aspect is capable of generating an intake noise of the engine 13, including the acoustic component belonging to the frequency band based on the rotational frequency fq of the engine 13, as the sound effect, to thereby create a natural sound effect which gives the driver a satisfactory sense of maneuverability. This is because the intake pipe microphone 37 detects the vibration noise signal produced in the intake pipe 39 through which the engine 13 and the air cleaner 41 communicate with each other as the vibration noise signal produced in the intake-side member for the engine 13.

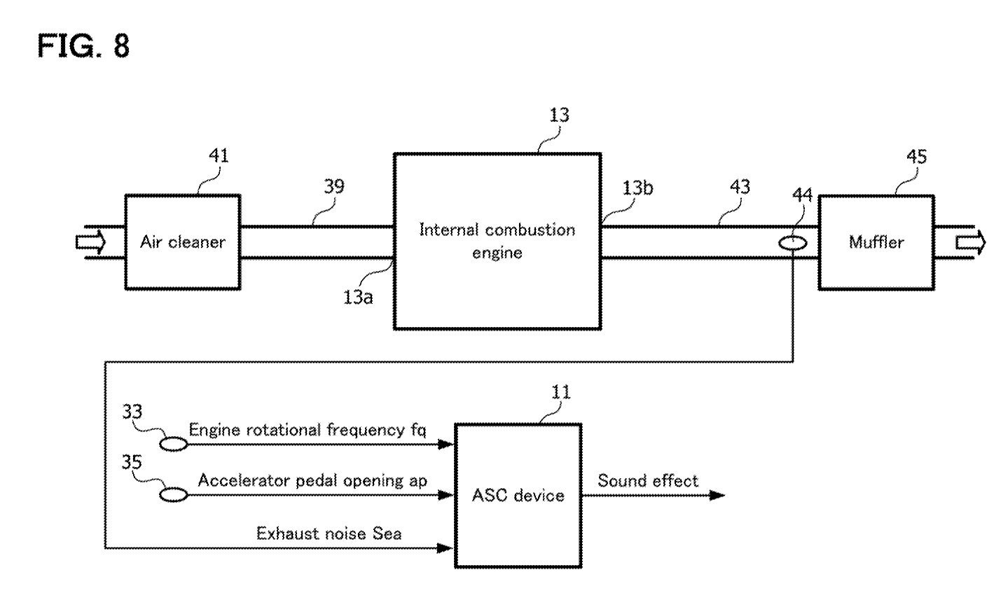

The active sound effect generation system 19 according to a fifth aspect is the active sound effect generation system 19 according to any one of the first to third aspects, characterized in that the exhaust pipe microphone (vibration noise signal detector) 44 detects the vibration noise signal produced in the exhaust pipe 43 through which the engine 13 and a muffler 45 communicate with each other as the vibration noise produced in the exhaust-side member for the engine 13, as illustrated in FIG. 8.

The active sound effect generation system 19 according to the fifth aspect is capable of generating an exhaust noise of the engine 13, including the acoustic component belonging to the frequency band based on the rotational frequency fq of the engine 13, as the sound effect, to thereby create a natural sound effect which gives the driver a satisfactory sense of maneuverability. This is because the exhaust pipe microphone 44 detects the vibration noise signal produced in the exhaust pipe 43 through which the engine 13 and the muffler 45 communicate with each other as the vibration noise produced in the exhaust-side member for the engine 13.

### Other Embodiments

The above-discussed multiple embodiments are examples of the embodiment of the present invention. For this reason, these embodiments shall not be construed as limiting the technical scope of the present invention. This is because the present invention can be carried out in various modes without departing from the gist, spirit or primary feature of the present invention.

For example, although the configuration of the vibration noise signal detector according to the present invention has been described using the intake pipe microphone 37 and the exhaust pipe microphone 44 as examples, the present invention is not limited to those examples. Instead of the intake pipe microphone 37 and the exhaust pipe microphone 44, a sensor for detecting an acoustic signal having correlations with the acoustic signals which are based on the combustion operation of the engine 13 (for example, a vibration acceleration sensor for detecting an acceleration of the vibration of the engine, and the like) may be employed as the vibration noise signal detector depending on the necessity.

In addition, although the embodiments of the present invention have been described using the example where the active sound effect generation system 19 according to the present invention is applied to the vehicle 15 with the internal combustion engine 13 mounted thereon, the present invention is not limited to this example. For example, the present invention may be applied to all moving bodies with an internal combustion engine 13 mounted thereon, such as a helicopter, an aircraft, and a pleasure boat.

Moreover, although the embodiments of the present invention have been described using the example where the reference signal generator 55 includes the three acoustic component extractors (first, second and third acoustic component extractors SE_1, SE_2, SE_3) having a common function, the present invention is not limited to this example. An appropriate number of acoustic component extractors included in the reference signal generator 55 may be employed in the active sound effect generation device 11 depending on the distribution and the like of the frequency bands of interest in the vibration noise signal. In this case, the number and the like of the multipliers in the multiplier section 53 for obtaining and outputting higher order frequencies of the fundamental-order engine rotational frequency fq is changed depending on the number of acoustic component extractors.

Moreover, although the embodiments of the present invention have been described using the example where the control signal generator 57 for performing the predetermined process on the sound effect reference signal generated by the reference signal generator 55 is provided between the reference signal generator 55 and the adder ad2, the present invention is not limited to this example. The control signal generator 57 may be omitted. In this case, the adder ad2 may be connected directly to the rear part of the reference signal generator 55.

Although the embodiments of the present invention have been described using the example where the sound pressure corrector 61 for setting the gains to correct the sound pressure-frequency characteristics of the sound effect at a time point is provided after the adder ad2, the present invention is not limited to this example. Part or all of the function of the sound pressure corrector 61 may be omitted. In this case, if the first gain setter 63 is omitted, the frequency change amount calculator 59 for calculating the frequency change amount Δfqv, which is referred to by the first gain setter 63 to determine the gain, may be omitted as well.

### REFERENCE SIGNS LIST

11 active sound effect generation device
13 internal combustion engine
15 vehicle
19 active sound effect generation system
25 driver seat speaker (sound output device)
37 intake pipe microphone (vibration noise signal detector)
39 intake pipe (intake-side member)
41 air cleaner
43 exhaust pipe (exhaust-side member)
44 exhaust pipe microphone (vibration noise signal detector)
45 muffler
55 reference signal generator
ad2 adder (generator)
fq engine rotational frequency

1. An active sound effect generation system comprising:
a vibration noise signal detector for detecting a vibration noise signal produced in at least one of an intake-side member and an exhaust-side member for an internal combustion engine;
a sound output device for outputting a sound including a sound effect; and
an active sound effect generation device comprising:
a reference signal generator for extracting an acoustic component belonging to a predetermined frequency band based on a rotational frequency of the engine from the vibration noise signal, and generating a harmonic reference signal based on the extracted acoustic component; and,
a generator for generating a control signal to be used to generate the sound effect on the basis of the reference signal, and outputting the control signal to the sound output device,
wherein the reference signal generator sets a center frequency for the acoustic component on the basis of the rotational frequency of the engine.

2. The active sound effect generation system according to claim 1,
wherein the reference signal generator sets the center frequency for the acoustic component in such a way as to follow a change in the rotational frequency of the engine.

3. The active sound effect generation system according to claim 1,
wherein the reference signal generator sets a width of the predetermined frequency band of the acoustic component on the basis of the rotational frequency of the engine.

4. The active sound effect generation system according to claim 2,
wherein the reference signal generator sets a width of the predetermined frequency band of the acoustic component on the basis of the rotational frequency of the engine.

5. The active sound effect generation system according to claim 1,
wherein the vibration noise signal detector detects a vibration noise signal produced in an intake pipe member through which the engine and an air cleaner communicate with each other as the vibration noise signal produced in the intake-side member for the engine.

6. The active sound effect generation system according to claim 1,
wherein the vibration noise signal detector detects a vibration noise signal produced in an exhaust pipe member through which the engine and a muffler communicate with each other as the vibration noise signal produced in the exhaust-side member for the engine.

7. The active sound effect generation system according to claim 2,
wherein the vibration noise signal detector detects a vibration noise signal produced in an intake pipe member through which the engine and an air cleaner communicate with each other as the vibration noise signal produced in the intake-side member for the engine.

8. The active sound effect generation system according to claim 3,
wherein the vibration noise signal detector detects a vibration noise signal produced in an intake pipe member through which the engine and an air cleaner communicate with each other as the vibration noise signal produced in the intake-side member for the engine.

9. The active sound effect generation system according to claim 4,
wherein the vibration noise signal detector detects a vibration noise signal produced in an intake pipe member through which the engine and an air cleaner communicate with each other as the vibration noise signal produced in the intake-side member for the engine.

10. The active sound effect generation system according to claim 2,
wherein the vibration noise signal detector detects a vibration noise signal produced in an exhaust pipe member through which the engine and a muffler communicate with each other as the vibration noise signal produced in the exhaust-side member for the engine.

11. The active sound effect generation system according to claim 3,
wherein the vibration noise signal detector detects a vibration noise signal produced in an exhaust pipe member through which the engine and a muffler communicate with each other as the vibration noise signal produced in the exhaust-side member for the engine.

12. The active sound effect generation system according to claim 4,
wherein the vibration noise signal detector detects a vibration noise signal produced in an exhaust pipe member through which the engine and a muffler communicate with each other as the vibration noise signal produced in the exhaust-side member for the engine.
